(19) United States
(12) Patent Application Publication
(10) Pub. No.: US 2005/0276303 A1
(43) Pub. Date: Dec. 15, 2005

(54) External Cavity Laser

(75) Inventor: rong huang, westborough, MA (US)

Correspondence Address: RONG HUANG, 9016-102 CLIFF CAMERON DRIVE, CHARLOTTE, NC, 28269, US

(73) Assignee: rong huang, westborough,, MA (US)

(21) Appl. No.: 10/709,979

(22) Filed: Jun. 10, 2004

(51) Int. Cl. H01S 3/08

(52) U.S. Cl. 372/106; 372/92

(57) ABSTRACT

An laser cavity including a special wavelength selection filter is disclosed. The special wavelength selection filter comprises of one or two linear polarizer, two quarter waveplates, an etalon filter and an end reflector. The laser may oscillate on single wavelength or multiple wavelengths depending on the selection of the end reflector and the etalon filter. The laser is designed very compact without a wavelength locker to have a stable wavelength output.

### BACKGROUND OF INVENTION

1. Field of the Invention

The present invention generally relates to external cavity type lasers using a special type etalon to select oscillation wavelength and simplify the cavity configuration.

2. Description of the Related Art

Wavelength stable light sources are key optical components in Wavelength division multiplexing (WDM) systems, in which typically there are multiple separately modulated stable light sources as transmitters. These laser transmitters are designed or actively tuned to operate at different standard wavelengths, usually specified by International Telecommunication Union (ITU) as νₙ=νₒ+n×Δν, where νₒ is the central optical frequency 193.1 THz and Δν is the specified frequency channel spacing that may equal a multiple of 100 GHz or 50 GHz. The wavelength stable light sources are generally the distributed feedback laser (DFB) with an active wavelength control device called wavelength locker and the external cavity laser with an external feedback device, such as a fiber-bragg-grating and diffractive grating. In some cases, an etalon is disposed in the cavity as a wavelength selection device. However, the etalon should be set an angle against the optical path to avoid the direct reflection from the etalon into the gain medium. Since the etalon has a plurality of transmission peaks, the laser will oscillate on multiple wavelengths very likely. A narrow tunable filter is usually placed into the cavity with the etalon to select a specific etalon peak.

The DFB laser has a large chirp when it is directly modulated; therefore it is not an ideal light source for DWDM system and the wavelength locker also adds extra cost. The external cavity laser with fiber-bragg-grating feedback, as shown in FIG. 1, has a serious reliability issue. Also the overall length of an external cavity laser is so long to be directly modulated at high modulation late. It is pictured to work at a continuous operation. There is a requirement to have a light source with long term wavelength stability, low modulation chirp, and low cost. To directly modulate an external cavity laser at a high speed, e.g., 2.5 GHz, it is imperative to make the overall cavity length short. In our previous filing, U.S. 2004-0071181-A1, we proposed the concept of a retro-reflective etalon. The retro-reflective etalon has a comb type reflection spectrum. In this filing, we use the retro-reflective etalon as a feedback element to construct an external cavity laser with a single mode output or multiple mode output with substantially uniform intensity and with a very short overall cavity length.

### SUMMARY OF INVENTION

in this invention, we use an etalon in a laser cavity as a wavelength selection device and a narrow band filter as an end reflector, which only reflects a narrow slice of wavelength, of the cavity to select a cavity oscillating wavelength among the etalon peaks to achieve a single mode operation, as shown in FIG. 2. Alternatively, by using a thin film interference filter having a single, narrow transmission peak within a large wavelength range in the place of the etalon and the end reflector having a flat reflectivity over the wavelength range, the laser will oscillate on the transmission peak of the filter and has a single mode operation, too. In the FIG. 2, the etalon must be set an angle to the optical path to avoid the reflection from the etalon directly into the gain medium and the oscillation between the etalon and the end reflector, which is set perpendicular to the optical path.

If to avoid setting the etalon an angle against the optical path, instead of using etalon, a special device called retro-reflective etalon can be used, whose reflection spectrum shows a plurality of peaks. It acts as the end reflector of a laser cavity and the wavelength selector. Within the R-etalon, there are an etalon filter, which has two partially reflective mirrors, or surfaces, facing each other and separated by a certain gap which forms a cavity, two quarter waveplates, one or two polarizers and a partially reflective or perfectly reflective mirror, as shown in FIG. 3. The reflection optical spectrum of the R-etalon has the double-pass transmission characteristic of the etalon. The transmission optical spectrum of the R-etalon is with the transmission characteristic of the etalon. If ignoring the absorption of the R-etalon, the peak reflectivity of R-etalon is the reflectivity of the end reflector of the R-etalon.

As shown in the FIG. 3, the etalon is arranged in between two quarter waveplates. The sequence of the components are the first linear polarizer, the first quarter waveplate, the etalon, the second quarter waveplate, the second linear polarizer, and the end reflector. Physical contact or applying some adhesives may laminate all these components sequentially together. During the arrangement, using anti-reflection coating or applying refractive index matching adhesive minimize the unwanted reflection from the surface of the components and the interfaces between bonded two components.

The R-etalon working principle is described as follows. When the light passes through the linear polarizer, the light becomes linearly polarized. When the polarized light passes through the first quarter waveplate, it becomes a circularly polarized light. The circularly polarized light reflected back from the etalon passes through the first waveplate again and becomes a linearly polarized; but its polarization rotates overall 90 degree. The first polarizer absorbs the light. The light passing through the etalon passes through the second quarter waveplate and becomes linearly polarized. The optical axis of the second quarter waveplate is arranged along or perpendicular to the optical axis of the first quarter waveplate. The second polarizer is arranged to allow the light pass through. Then, the light reflects totally or partially back from the reflector. The reflected-back light passes the second quarter waveplate and becomes circularly polarized again. The partial of the light is reflected back from the etalon and passes the second quarter waveplate again and becomes linearly polarized and absorbed by the second polarizer. The light passing through the etalon and the first quarter waveplate becomes linearly polarized. The polarization changes totally 180 degree or 0 degree. It passes through the first polarizer. As the result, the light reflected from the device passes through the etalon twice and has the double-pass transmission characteristic of the etalon. If the reflector has a finite reflection, the transmission output from the R-etalon is linearly polarized. If the R-etalon is positioned perpendicular to the optical path, the peak positions of the R-etalon are much less sensitive to the beam steering (the beam direction deviating from the normal of the etalon). there is no light directly reflected back from the etalon. The R-etalon is an ideal device to be used to construct an external cavity laser.

As shown in FIG. 4, the R-etalon acts as one end reflector of a laser cavity. Because the R-etalon reflects back a plurality of peak, the laser cavity should oscillates on multiple peaks. This can be avoided by designing the end reflector of the R-etalon to be a narrow band pass filter, which only allows light reflection in the band and this band only covers the wanted peak wavelengths, as shown in FIG. 5. Or, by designing the spectrum of the reflectors on the gain medium to be a band-pass filter, the unwanted laser oscillation can also be avoided. Alternatively, if the etalon has a very large free spectrum range, it shows only one transmission peak within a large range of wavelength or this etalon is just a thin film interference filter coated on the quarter waveplate or a substrate having only one transmission peak in an interested wavelength range, e.g., the bandwidth of the gain profile and the end reflector of the R-etalon is flat in the wavelength range, the laser lases on single cavity mode, too.

Sometimes, a laser oscillating on multiple wavelengths with uniform peak intensity is desired. However, the gain profile is not uniform and mostly parabolic. A laser with a spectrum flat end reflector lases on the multiple peak wavelengths of the R-etalon with non-uniform output. To achieve a uniform and multiple wavelength output, the non-uniform gain profile should be compensated. FIG. 6 shows that the end reflector has a special spectrum to compensate the gain profile of the gain medium. The peak wavelengths of the R-etalon can be adjusted thermally or electrically. The adjustment depends on the material used in the etalon cavity. If the etalon is made of a thermally stable material, such as Schnaelite described by Ackerman et al. in his paper “Low-cost athermal wavelength-locker integrated in a temperature-tuned single-frequency laser package”, J. lightwave tech., vol. 22, p 166-171, the output wavelength is stable against temperature fluctuation.

The above and other features of the invention including various novel details of construction and combinations of parts, and other advantages, will now be more particularly described with reference to the accompanying drawings. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF DRAWINGS

In the accompanying drawings, reference characters refer to the same parts through the different views. The drawings are not necessarily to scale; emphasis has instead been placed upon illustrating the principles of the invention. Of the drawings:

FIG. 1 shows an external cavity laser with a fiber bragg grating as one of its end reflector.

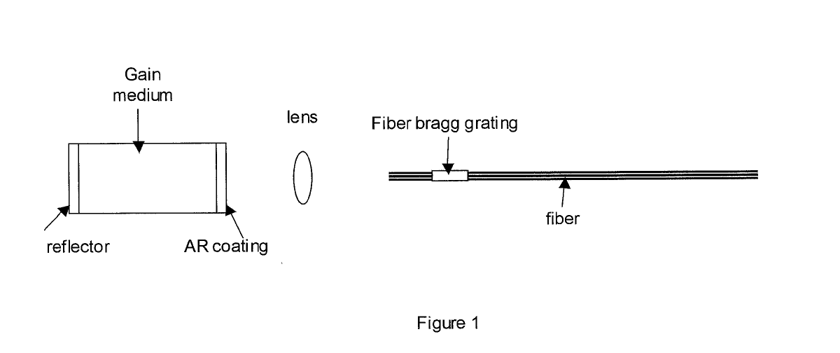

FIG. 2 illustrates an external cavity laser with an etalon as its wavelength selector and the etalon is set an angle against the optical path.

FIG. 3 shows schematically a R-etalon with all its components laminated together and the optical axis of the components.

FIG. 4 shows a laser cavity with a R-etalon.

FIG. 5 illustrates the reflection spectrum of the reflector on the gain medium or R-etalon, which has a band pass characteristic and covers only one peak of the R-etalon.

FIG. 5a shows that the etalon has a wide free spectrum range and the reflector(s) has a relatively flat reflectivity over the bandwidth of the gain profile.

FIG. 6 illustrates the end reflector having a special spectrum characteristics to compensate the gain profile of the gain medium.

FIG. 7 illustrates the match of the reflection peaks of the R-etalon with some of the cavity modes.

### DETAILED DESCRIPTION

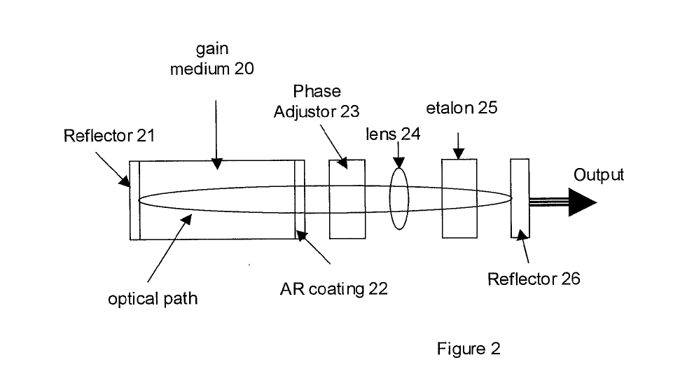

A laser cavity generally consists of a gain medium and wavelength feedback and selection mechanism. In FIG. 2, the etalon 25 is placed in a laser cavity as a wavelength selector. Since the etalon produces a plurality of peaks, to achieve a single wavelength oscillation, an etalon peak selector should be used in the cavity, too. For example, the reflector 21 or reflector 26 or both are designed to be band pass reflector, which only reflects a slice of wavelength. If the slice spectrum of the reflector covers only one etalon peak, the laser cavity will oscillate only on one wavelength. The etalon 25 in FIG. 2 should be set an angle against the optical path to avoid the interference between the etalon and the end reflector 26 and the direct reflection from the etalon into the gain medium 20. The use of a R-etalon can avoid these problems. In order to achieve single mode operation, alternatively, the etalon can be designed to have a wide free spectrum range (FSR) and the reflector 21, or 26 has a flat reflectivity. Or the etalon is just an interference filter coated on a substrate with a single transmission peak.

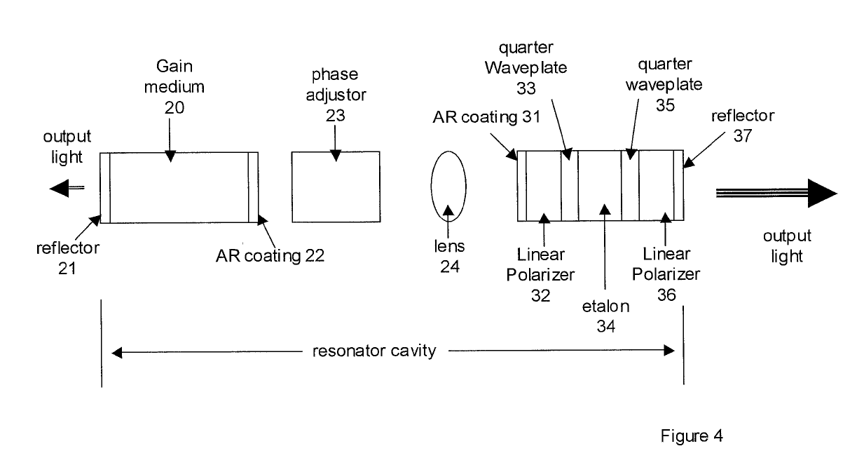

The proposed laser cavity, illustrated in FIG. 4, consists of a gain medium 20, a cavity phase adjustor 23, and a R-etalon. The R-etalon comprises an etalon 34 and a few other optical components, such as linearly polarizer 32 36 and quarter waveplates, 33, 35. All components are commercially available or easily manufactured by existing technology. The reflection optical spectrum of the R-etalon has the double-pass transmission characteristic of the etalon. The etalon 34 can be made of a solid material or air-spaced. To achieve the required reflectivity of the etalon, its surface can be coated multi-layers of dielectric materials, as known in the art. The etalon can be designed to have specific free space range (FSR) by using different spacing thickness or different material with a different refractive index.

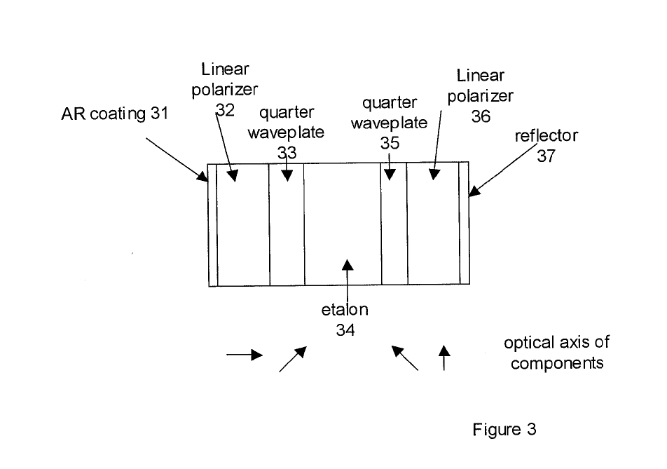

FIG. 3 shows a R-etalon. The arrangement reduces dramatically the interference between the etalon 34 and the end reflector 37, which is arranged substantially in parallel to the etalon 34. The reflector 37 reflects totally or partially the incoming light. In order to save cost and space, this reflector can be a reflection coating on the linear polarizer 36. The light incident on the R-etalon is reflected back with the double-pass characteristic of the etalon. The reflected light is fed back into the gain medium 20. The light beam points substantially perpendicularly to the R-etalon. The linear polarizer 32, 36 allows the light of the polarization in parallel to its optical axis passes through and the light then becomes linearly polarized.

The R-etalon works this way. When light passes through the first polarizer 32 on which an anti-reflection coating is applied to prevent the light reflected from the polarizer into the gain medium, it becomes linearly polarized. When the linearly polarized light passes through the first quarter waveplate 33, it becomes a circularly polarized light. The light reflected back from the etalon 34 passes through the first waveplate 33 twice and becomes linearly polarized; but its polarization rotates overall 90 degree and the first polarizer 32 absorbs it. When the light passes through the etalon 34 and the second quarter waveplate 35, it becomes linearly polarized again. The second polarizer 36 is so arranged to allow it passing through. Then, the light reflects totally or partially back from the reflector 37. The reflected-back light passes the second polarizer 36 and the second quarter waveplate 35 again and becomes circularly polarized. The circularly polarized light reflects back from the etalon 34 and passes the second quarter waveplate 35 twice and it becomes linearly polarized and is absorbed by the second polarizer 36. The light passing through the etalon 34 goes through the first quarter waveplate 33 second time and becomes linearly polarized. The polarization changes overall 180 degree or 0 degree, which depends on the arrangement of the first and second quarter waveplates and then it passes through the first polarizer 32. As the result, the light reflected from the device passes through the etalon twice.

All components in R-etalon can be laminated together. The end reflector 37 can be a reflective coating on the polarizer 36. In order to save assembly cost, a large piece of laminated R-etalon can be made; then it is diced into small pieces with a required size. The advantage of the laminated retro-reflective etalon is the ease to assembly and the simplicity to align. For example, if the polarizer 32 is a Polarcor™ linear polarizer and the waveplate 33 is made from quartz, two pieces can be epoxied together by using an index-matching epoxy or just by using optical contact, since the Polarcor™ has a refractive index very close to that of the quartz. The reflection at the interface is very small. If the refractive index difference is large between two components, some kind of coating should be applied first before using epoxy or optical contact method to minimize the interface reflection.

The etalon 34 in the R-etalon can be an air-spaced etalon, which is made little temperature-dependence or a solid etalon. Usually, the refractive index of the solid material in the etalon cavity is wavelength dependent, or called dispersion. Because of the interested frequency range is usually very small, for example, “C” band or “L” band, the dispersion is approximated as a linear function of frequency. During the design, the linearly frequency-dependent dispersion can be compensated by finding the etalon thickness using the formula
L=kc/[2(n(ν)ν−n(ν−K*FSR)(ν−k*FSR))], where L is the thickness of the etalon, k is an integer, c is the speed of light, ν is the frequency, and FSR is the designated free space range. The k is chose to let ν to ν−k*FSR to cover the central half of the interested frequency range. Because the refractive index and the physical thickness of the solid material can be adjusted thermally, the FSR of the etalon alters accordingly. If the material has electro-optical, magnetic-optical, piezo-electrical properties, applying electrical or magnetic field can change the FSR of the said etalon, too. Then, the peaks of the R-etalon can be adjusted to match to ITU frequencies in the interested frequency range. If the etalon is made of a material having a very small temperature dependence of refractive index and thermal expansion coefficient, the etalon peaks are thermally stable against thermal fluctuation.

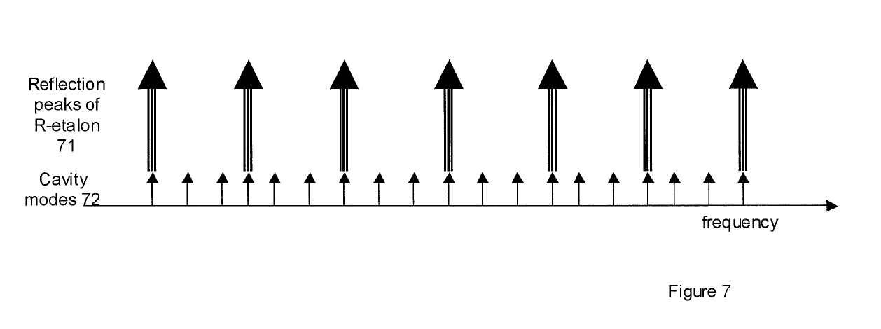

FIG. 4 proposes an embodiment to show the application of the R-etalon in a laser cavity. In the embodiment, there is a gain medium made of semiconductor optical amplifier (SOA) 20 in the cavity. The gain medium can be other material, such as Nd-YAG and Nd-glass. The SOA has two facets. One has a high reflection coating and the second facet has low reflection, which is done by anti-reflection coating, angle cleaving, or both. A phase adjustor 23 is also included in the cavity. The reason is that the cavity mode of the laser may mis-match the peak wavelength of the R-etalon. The phase adjustor 23 can be used to shift the cavity mode 72 wavelength to match the peak wavelength 71 of the R-etalon, as shown in FIG. 7. The wavelengths of the cavity modes are determined by the length of the cavity and the phase shift introduced by the etalon in the cavity. If the etalon transmission peak have a narrow band, the modes mis-matching the etalon peaks would be substantially suppressed. The phase shift of the cavity mode can be realized by various ways. One is, if all the optical components are disposed on one platform, by heating the platform. Second is, if the gain medium and the R-etalon are disposed on two separate platforms, by heating the platform with the gain medium. Third is by integrating a waveguide section with the SOA and injecting current into the waveguide to change the cavity phase. There are other methods to change the cavity phase, such as by changing the injection current into the SOA, by heating the SOA, by changing the optical path of the a slab of material disposed in the cavity thermally or electrically, or by precisely adjusting the cavity length, to let the peaks of the R-etalon match the cavity modes at assembly. If the emission light from the gain medium, such as SOA is substantially linearly polarized, the first linear polarizer is not necessary to be used. The reason is that the polarization of the light reflected back from the etalon is changed 90 degree which will not be amplified by the gain medium.

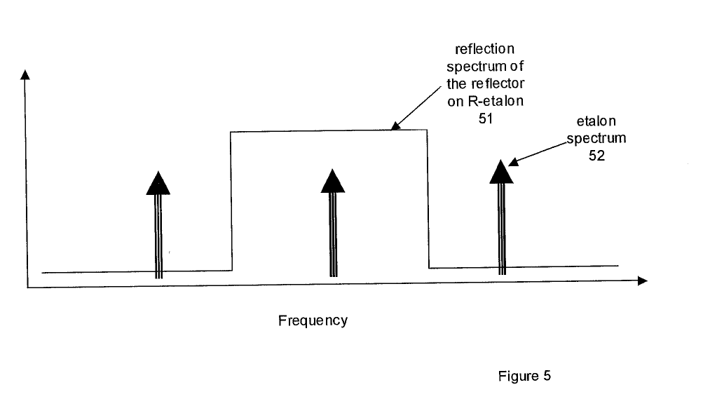

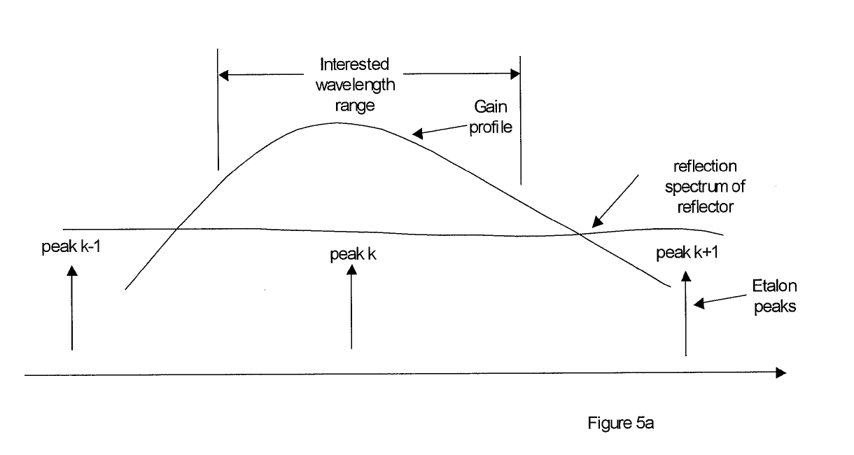

FIG. 5 shows one of possible reflection spectra of the reflector on the gain medium or R-etalon and the transmission peaks of the etalon. The spectrum of the reflector is a band pass filter to reflect a narrow slice 51 of wavelength. FIG. 5 also shows the narrow slice covering only one peak of the etalon 34. The laser will lase on the peak of the R-etalon. The laser has a single mode operation. Another way to achieve a single mode operation is to design the free space range of the etalon 34 is wide enough to allow the gain curve to cover only one etalon peak within an interested wavelength range, as shown in FIG. 5a. Therefore, only one peak wavelength has a enough gain to lase, even though the end reflector has a flat reflection spectrum. The etalon 34 can be just a thin film interference filter, which has one transmission peak within the interested wavelength range, on quarter waveplate 33 or 35 or on a separate substrate, in which the reflection spectrum of the reflector(s) shows a flat line. The thin film interference filter can be a tapered thin film interference filter as disclosed in U.S. Pat. No. 6,717,965 by Hopkin, et al. The cavity oscillation wavelength is selected by changing the passing position of the optical beam on the filter. Since the gain profile has a parabolic profile, as shown in FIG. 5a, the laser will lase at the peak k wavelength and will not lase at the peak k−1 and k+1 wavelength due to the large gain difference. The overall thickness of the R-etalon can be less than 1 mm. The length from the facet 22 of the gain medium to the reflector 37 can be design to be less than 3 mm.

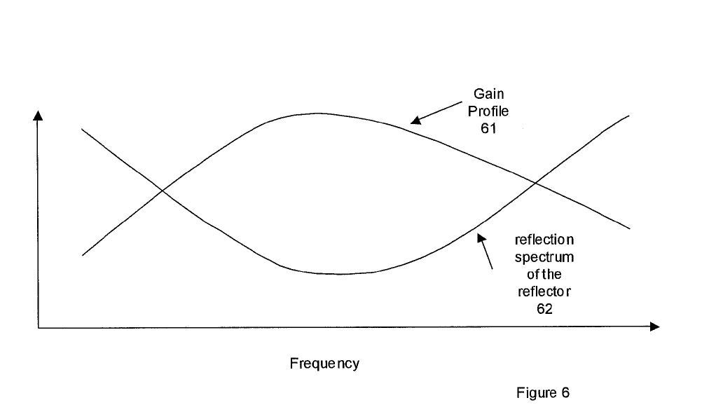

In order to let the laser lases on the multi-peak wavelengths of the R-etalon and the output has uniform peak intensity, the reflector is designed to have a spectrum of special shape 62 to compensate the non-uniform gain profile 61 of the gain medium to achieve a flat cavity gain profile, as shown in the FIG. 6. The overall cavity gain is flat over a range of wavelength. The laser will oscillate on multiple etalon peak wavelengths with a uniform output intensity.

While the invention has been shown and described with reference to specific preferred embodiment, it should be understood by those skilled in the art that various changes in form and detail may be made therein without departing from the spirit and scope of the invention as defined by the following claims.

1. An external cavity laser comprising:
a gain medium having a highly reflective facet and a highly transmissive facet a cavity phase adjustor;
a retro-reflective etalon comprising:
(a) the first linear polarizer (if the emission light from the gain medium is substantially polarized, this polarizer is not necessary), the first quarter waveplate, the etalon filter, the second quarter waveplate, the second linear polarizer, the end mirror reflector;
(b) the end reflector arranged in substantial or perfect parallel to the etalon filter;
(c) the optical axes of the two quarter waveplates arranged in parallel or perpendicular;
(d) the first quarter waveplate to rotate the polarization of the light reflected from the etalon and the first polarizer to absorb the light;
(e) the second quarter waveplate to rotate the polarization of the light reflected from the etalon and the second polarizer to absorb the light;
the highly transmissive facet of the gain medium facing the retro-reflective etalon;
the light reflected back from the retro-reflective etalon being fed back into said gain medium;
the output light of the said laser from the end reflector of the retro-reflective etalon and the highly reflective facet of the gain medium.

2. The laser of claim 1 wherein the highly reflective facet of the gain medium comprises one of a cleaved facet, a high reflection coated facet, a coated band-pass reflective filter on the facet, a coated special filter on the facet to compensate the gain profile of the gain medium.

3. The laser of claim 1 wherein the highly transmissive facet of the gain medium comprises one of an angle cleaved facet, anti-reflection coated facet, angle cleaved and anti-reflective coated facet.

4. The laser of claim 1 wherein the cavity phase adjustor is the means to adjust the cavity length to match the cavity mode(s) to the etalon peak(s).

5. The laser of claim 1 wherein the etalon filter is an air-spaced etalon defined by a first partial reflector and a second partial reflector, said reflectors mounted in a parallel spaced-apart relationship to form a gap in between.

6. The laser of claim 1 wherein the etalon filter is defined by a first partial reflector and a second partial reflector, said reflectors formed on the two parallel surfaces of a piece of transparent material.

7. The etalon filter of claim 5 wherein the optical path thickness of the transparent material can be changed thermally or by applying an electrical field or chosen thermally stable.

8. The laser of claim 1 wherein the etalon filter is a thin film interference filter or a tapered thin film interference filter on a substrate of one transmission peak within a wavelength range defined by the requirement of single mode operation.

9. The laser of claim 1 wherein the linear polarizer only lets light with the polarization in parallel to its optical axis to pass through substantially.

10. The laser of claim 1 wherein the quarter waveplates are respectively made of a material selected from a group consisting of birefringent crystals and liquid crystals.

11. The laser of the claim 1 wherein the reflector of the R-etalon comprises one of reflection filter, band-pass reflective filter, and the filter of special reflection spectrum to compensate the gain curve of the gain medium.
